(19) United States
(12) Patent Application Publication
(10) Pub. No.: US 2017/0323042 A1
(43) Pub. Date: Nov. 9, 2017

(54) Simulation Processor with Backside Look-Up Table

(71) Applicant: ChengDu HaiCun IP Technology LLC, ChengDu (CN)

(72) Inventor: Guobiao ZHANG, Corvallis, OR (US)

(73) Assignee: ChengDu HaiCun IP Technology LLC, ChengDu (CN)

(21) Appl. No.: 15/587,369

(22) Filed: May 4, 2017

(30) Foreign Application Priority Data
May 4, 2016 (CN) 201610294268.X
May 3, 2017 (CN) 201710302440.6

(51) Int. Cl. G06F 17/50; G06F 7/487; G06F 7/483

(52) U.S. Cl. CPC G06F 17/5022; G06F 7/483; G06F 7/4876

(57) ABSTRACT

The present invention discloses a simulation processor for simulating a system comprising a system component. The simulation processor comprises a look-up table circuit (LUT) and an arithmetic logic circuit (ALC). The LUT is formed on the backside of the processor substrate and stores data related to a mathematical model of the system component. The ALC is formed on the front side of the processor substrate and performs arithmetic operations on the model-related data. The LUT and the ALC are communicatively coupled by a plurality of through-silicon vias (TSV).

### CROSS-REFERENCE TO RELATED APPLICATIONS

This application claims priority from Chinese Patent Application 201610294268.X, filed on May 4, 2016; Chinese Patent Application 201710302440.6, filed on May 3, 2017, in the State Intellectual Property Office of the People's Republic of China (CN), the disclosure of which are incorporated herein by references in their entireties.

### BACKGROUND

### 1. Technical Field of the Invention

The present invention relates to the field of integrated circuit, and more particularly to processors used for modeling and simulation of a physical system.

### 2. Prior Art

Conventional processors use logic-based computation (LBC), which carries out computation primarily with logic circuits (e.g. XOR circuit). Logic circuits are suitable for arithmetic operations (i.e. addition, subtraction and multiplication), but not for non-arithmetic functions (e.g. elementary functions, special functions). Non-arithmetic functions are computationally hard. Rapid and efficient realization of the non-arithmetic functions has been a major challenge.

For the conventional processors, only few basic non-arithmetic functions (e.g. basic algebraic functions and basic transcendental functions) are implemented by hardware and they are referred to as built-in functions. These built-in functions are realized by a combination of arithmetic operations and look-up tables (LUT). For example, U.S. Pat. No. 5,954,787 issued to Eun on Sep. 21, 1999 taught a method for generating sine/cosine functions using LUTs; U.S. Pat. No. 9,207,910 issued to Azadet et al. on Dec. 8, 2015 taught a method for calculating a power function using LUTs.

Realization of built-in functions is further illustrated in FIG. 1AA. A conventional processor 00X generally comprises a logic circuit 100X and a memory circuit 200X. The logic circuit 100X comprises an arithmetic logic unit (ALU) for performing arithmetic operations, whereas the memory circuit 200X comprises a look-up table circuit (LUT) for storing data related to the built-in function. To achieve a desired precision, the built-in function is approximated to a polynomial of a sufficiently high order. The LUT 200X stores the coefficients of the polynomial; and the ALU 100X calculates the polynomial. Because the ALU 100X and the LUT 200X are formed side-by-side on a semiconductor substrate 00S, this type of horizontal integration is referred to as two-dimensional (2-D) integration.

The 2-D integration puts stringent requirements on the manufacturing process. As is well known in the art, the memory transistors in the LUT 200X are vastly different from the logic transistors in the ALC 100X. The memory transistors have stringent requirements on leakage current, while the logic transistors have stringent requirements on drive current. To form high-performance memory transistors and high-performance logic transistors on the same surface of the semiconductor substrate 00S at the same time is a challenge.

The 2-D integration also limits computational density and computational complexity. Computation has been developed towards higher computational density and greater computational complexity. The computational density, i.e. the computational power (e.g. the number of floating-point operations per second) per die area, is a figure of merit for parallel computation. The computational complexity, i.e. the total number of built-in functions supported by a processor, is a figure of merit for scientific computation. For the 2-D integration, inclusion of the LUT 200X increases the die size of the conventional processor 00X and lowers its computational density. This has an adverse effect on parallel computation. Moreover, because the ALU 100X, as the primary component of the conventional processor 00X, occupies a large die area, the LUT 200X, occupying only a small die area, supports few built-in functions. FIG. 1AB lists all built-in transcendental functions supported by an Intel Itanium (IA-64) processor (referring to Harrison et al. “The Computation of Transcendental Functions on the IA-64 Architecture”, Intel Technical journal, Q4 1999, hereinafter Harrison). The IA-64 processor supports a total of 7 built-in transcendental functions, each using a relatively small LUT (from 0 to 24 kb) in conjunction with a relatively high-order Taylor series (from 5 to 22).

This small set of built-in functions (˜10 types, including arithmetic operations) is the foundation of scientific computation. Scientific computation uses advanced computing capabilities to advance human understandings and solve engineering problems. It has wide applications in computational mathematics, computational physics, computational chemistry, computational biology, computational engineering, computational economics, computational finance and other computational fields. The prevailing framework of scientific computation comprises three layers: a foundation layer, a function layer and a modeling layer. The foundation layer includes built-in functions that can be implemented by hardware. The function layer includes mathematical functions that cannot be implemented by hardware (e.g. non-basic non-arithmetic functions). The modeling layer includes mathematical models of a system to be simulated (e.g. an electrical amplifier) or a system component to be modeled (e.g. a transistor in the electrical amplifier). The mathematical models are the mathematical descriptions of the input-output characteristics of the system to be simulated or the system component to be modeled. They could be either the measurement data (the measurement data could be raw measurement data or smoothed measurement data), or the mathematical expressions extracted from the raw measurement data.

In prior art, the mathematical functions in the function layer and the mathematical models in the modeling layer are implemented by software. The function layer involves one software-decomposition step: mathematical functions are decomposed into combinations of built-in functions by software, before these built-in functions and the associated arithmetic operations are calculated by hardware. The modeling layer involves two software-decomposition steps: the mathematical models are first decomposed into combinations of mathematical functions; then the mathematical functions are further decomposed into combinations of built-in functions. Apparently, the software-implemented functions (e.g. mathematical functions, mathematical models) run much slower and less efficient than the hardware-implemented functions (i.e. built-in functions). Moreover, because more software-decomposition steps lead to more computation, the mathematical models (with two software-decomposition steps) suffer longer delay and more energy consumption than the mathematical functions (with one software-decomposition step).

To illustrate the computational complexity of a mathematical model, FIGS. 1BA-1BB disclose a simple example—the simulation of an electrical amplifier 500. The system to be simulated, i.e. the electrical amplifier 500, comprises two system components, i.e. a resistor 510 and a transistor 520 (FIG. 1BA). The mathematical models of transistors (e.g. MOS3, BSIM3, BSIM4, PSP) are based on the small set of built-in functions supported by the conventional processor 00X, i.e. they are expressed by a combination of these built-in functions. Due to the limited choice of the built-in functions, calculating even a single current-voltage (I-V) point for the transistor 520 requires a large amount of computation (FIG. 1BB). As an example, the BSIM4 transistor model needs 222 additions, 286 multiplications, 85 divisions, 16 square-root operations, 24 exponential operations, and 19 logarithmic operations. This large amount of computation makes modeling and simulation extremely slow and inefficient.

### Objects and Advantages

It is a principle object of the present invention to realize rapid and efficient modeling and simulation.

It is a further object of the present invention to reduce the modeling time.

It is a further object of the present invention to reduce the simulation time.

It is a further object of the present invention to lower the modeling energy.

It is a further object of the present invention to lower the simulation energy.

It is a further object of the present invention to provide a processor with improved computational complexity.

It is a further object of the present invention to provide a processor with improved computational density.

It is a further object of the present invention to provide a processor with a large set of built-in functions.

It is a further object of the present invention to realize non-arithmetic functions rapidly and efficiently.

In accordance with these and other objects of the present invention, the present invention discloses a processor with a backside look-up table (BS-LUT).

### SUMMARY OF THE INVENTION

The present invention discloses a processor with a backside look-up table (BS-LUT) (i.e. BS-LUT processor). The BS-LUT processor comprises a logic circuit and a memory circuit. The logic circuit is formed on the front side of the processor substrate and comprises at least an arithmetic logic circuit (ALC), whereas the memory circuit is formed on the backside of the processor substrate and comprises at least a look-up table circuit (LUT). The ALC and LUT are communicatively coupled by a plurality of through-silicon vias (TSV). Located on the backside of the processor substrate, the LUT is referred to as backside LUT (BS-LUT). The BS-LUT stores data related to a function, while the ALC performs arithmetic operations on the function-related data.

The BS-LUT processor uses memory-based computation (MBC), which carries out computation primarily with the LUT. Compared with the LUT used by the conventional processor, the BS-LUT used by the BS-LUT processor has a much larger capacity. Although arithmetic operations are still performed, the MBC only needs to calculate a polynomial to a lower order because it uses a larger BS-LUT as a starting point for computation. For the MBC, the fraction of computation done by the BS-LUT could be more than the ALC.

Because the ALC and the LUT are located on different sides of the processor substrate, this type of vertical integration is referred to as double-side integration. The double-side integration has a profound effect on the computational density and computational complexity. For the conventional 2-D integration, the footprint of a conventional processor 00X is roughly equal to the sum of those of the ALU 100X and the LUT 200X. On the other hand, because the double-side integration moves the LUT from aside to the backside, the BS-LUT processor becomes smaller and computationally more powerful. In addition, the total LUT capacity of the conventional processor 00X is less than 100 kb, whereas the total BS-LUT capacity for the BS-LUT processor could reach 100 Gb. Consequently, a single BS-LUT processor could support as many as 10,000 built-in functions (including various types of complex mathematical functions), far more than the conventional processor 00X. Furthermore, because the ALC and the LUT are on different sides of the processor substrate, the logic transistors in the ALC and the memory transistors in the LUT are formed in separate processing steps, which can be individually optimized.

Significantly more built-in functions shall flatten the prevailing framework of scientific computation (including the foundation, function and modeling layers). The hardware-implemented functions, which were only available to the foundation layer in prior art, now become available to the function and modeling layers. Not only the mathematical functions in the function layer can be directly realized by hardware, but also the mathematical models in the modeling layer. In the function layer, the mathematical functions can be realized by a function-by-LUT method, i.e. the function values are calculated by interpolating the function-related data stored in the BS-LUT. In the modeling layer, the mathematical models can be realized by a model-by-LUT method, i.e. the input-output characteristics of a system component are modeled by interpolating the model-related data stored in the BS-LUT. Rapid and efficient computation would lead to a paradigm shift for scientific computation.

To improve the speed and efficiency of modeling and simulation, the present invention discloses a simulation processor with a BS-LUT (i.e. BS-LUT simulation processor). This BS-LUT simulation processor is a BS-LUT processor used for modeling and simulation. The to-be-simulated system (e.g. an electrical amplifier 500) comprises at least a to-be-modeled system component (e.g. a transistor 520). The BS-LUT simulation processor comprises a logic circuit and a memory circuit. The BS-LUT in the memory circuit stores data related to a mathematical model of the system component (e.g. the transistor 520), whereas the ALC in the logic circuit performs arithmetic operations on the model-related data. The logic circuit and the memory circuit are located on different sides of the processor substrate.

Accordingly, the present invention discloses a simulation processor for simulating a system comprising a system component, comprising: a semiconductor substrate comprising a front side and a backside; a look-up table circuit (LUT) formed on said backside for storing data related to a mathematical model of said system component; an arithmetic logic circuit (ALC) formed on said front side for performing arithmetic operations on said data; and a plurality of through-silicon vias (TSV) through said semiconductor substrate for communicatively coupling said memory circuit and said logic circuit.

### BRIEF DESCRIPTION OF THE DRAWINGS

FIG. 1AA is a schematic view of a conventional processor (prior art); FIG. 1AB lists all transcendental functions supported by an Intel Itanium (IA-64) processor (prior art); FIG. 1BA is a circuit block diagram of an electrical amplifier; FIG. 1BB lists the number of operations for various transistor models (prior art);

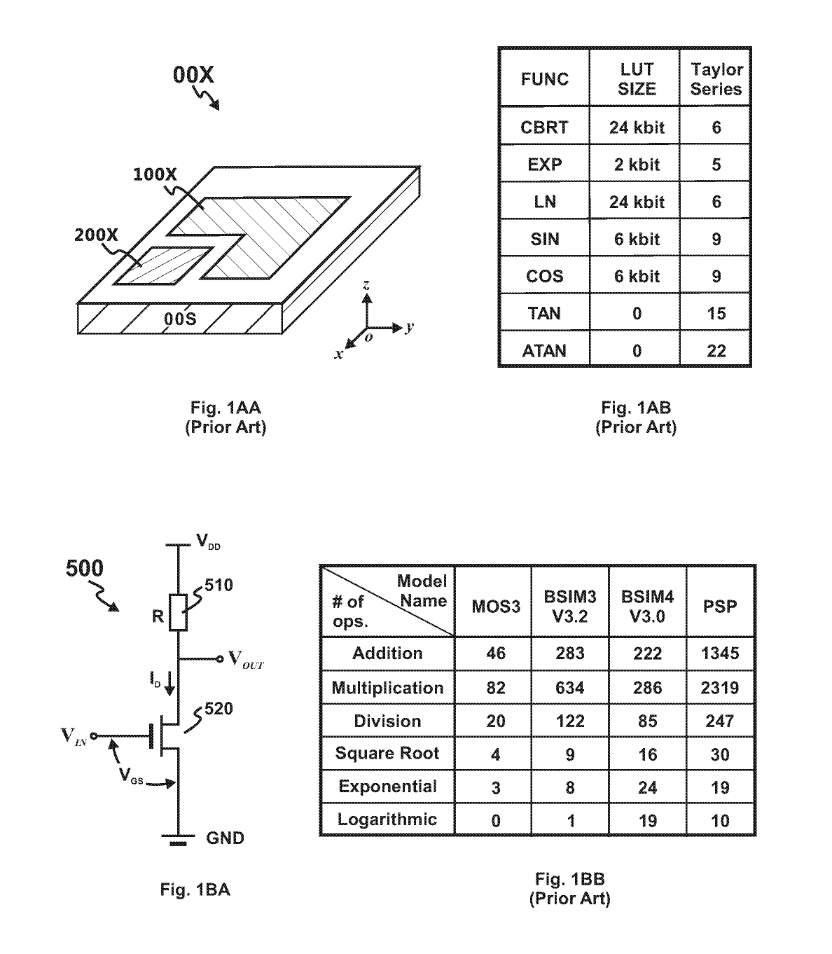

FIG. 2A is a simplified block diagram of a preferred BS-LUT processor; FIG. 2B is a perspective view of the front side of the preferred BS-LUT processor; FIG. 2C is a perspective view of the backside of the preferred BS-LUT processor;

FIG. 3A is a cross-sectional view of a preferred BS-LUT processor; FIG. 3B is a circuit layout view of the front side of the preferred BS-LUT processor; FIG. 3C is a circuit layout view of the backside of the preferred BS-LUT processor;

FIG. 4A is a simplified block diagram of a preferred BS-LUT processor realizing a mathematical function; FIG. 4B is a block diagram of a preferred BS-LUT processor realizing a single-precision mathematical function; FIG. 4C lists the LUT size and Taylor series required to realize mathematical functions with different precisions;

FIG. 5 is a block diagram of a preferred BS-LUT processor realizing a composite function;

FIG. 6 is a block diagram of a preferred BS-LUT simulation processor.

It should be noted that all the drawings are schematic and not drawn to scale. Relative dimensions and proportions of parts of the device structures in the figures have been shown exaggerated or reduced in size for the sake of clarity and convenience in the drawings. The same reference symbols are generally used to refer to corresponding or similar features in the different embodiments. The symbol “/” means a relationship of “and” or “or”. Throughout the present invention, both “look-up table” and “look-up table circuit” are abbreviated to LUT. Based on context, the LUT may refer to a look-up table or a look-up table circuit.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

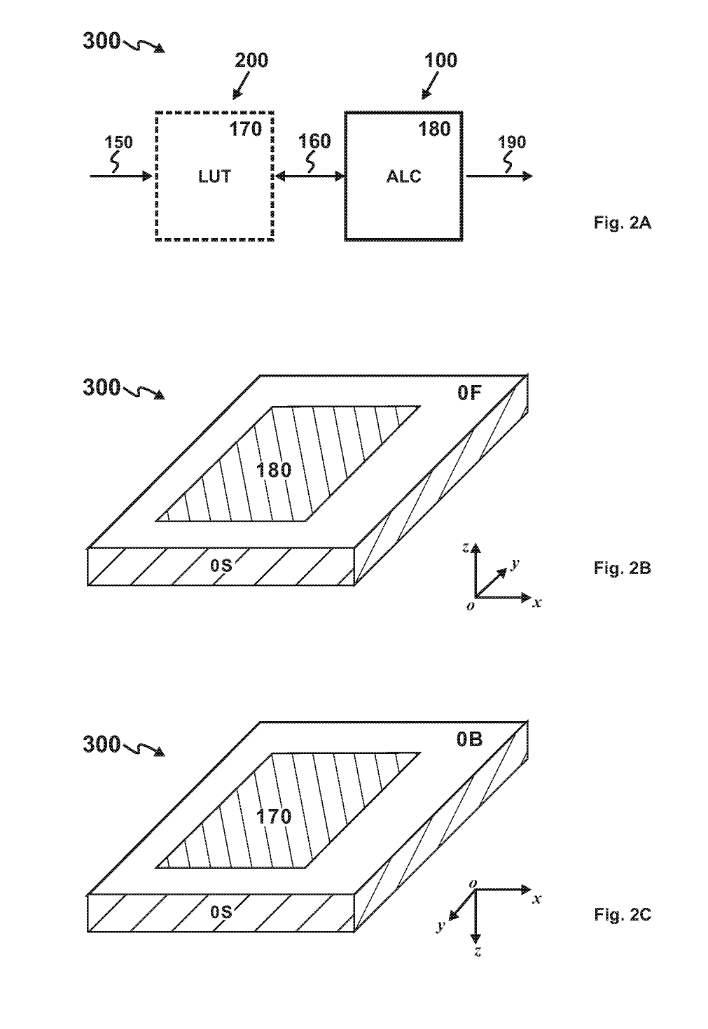

Referring now to FIG. 2A-2C, a preferred BS-LUT processor 300 is disclosed. The BS-LUT processor 300 has one or more inputs 150, and one or more outputs 190. The BS-LUT processor 300 further comprises a logic circuit 100 and a memory circuit 200. The logic circuit 100 is formed on the front side 0F of the processor substrate 0S and comprises at least an arithmetic logic circuit (ALC) 180, whereas the memory circuit 200 is formed on the backside 0B of the processor substrate 0S and comprises at least a look-up table circuit (LUT). The ALC 180 and LUT 170 are communicatively coupled by a plurality of through-silicon vias (TSV) 160. Located on the backside 0B of the processor substrate 0S, the LUT 170 is referred to as backside LUT (BS-LUT). The BS-LUT 170 stores data related to a function, while the ALC 180 performs arithmetic operations on the function-related data. Because they are formed on different sides 0F, 0B of the processor substrate 0S, the BS-LUT 170 is represented by dashed lines and the ALC 180 is represented by solid lines throughout the present invention.

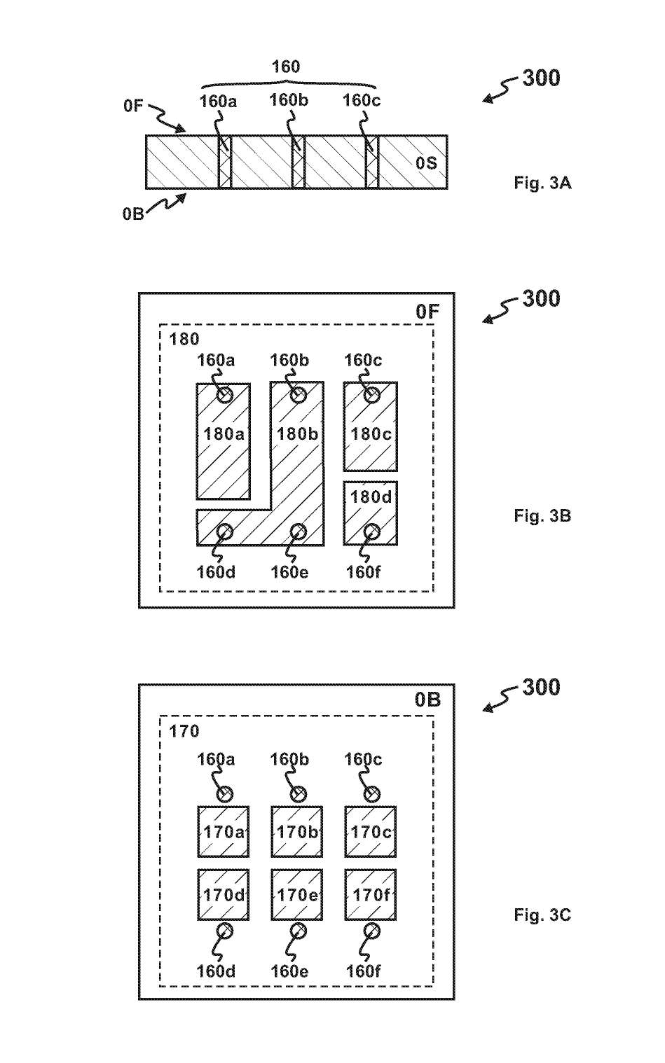

Referring now to FIGS. 3A-3C, more details of the preferred BS-LUT processor 300 are shown. The BS-LUT processor 300 comprises a plurality of TSVs 160a, 160b, . . . through the processor substrate 0S (FIG. 3A). The front side 0F of the processor substrate 0S comprises ALC 180, including a plurality of ALC components 180a-180d . . . (FIG. 3B). These ALC components 180a-180d are communicatively coupled with the TSVs 160a-160d. On the other hand, the backside 0B of the processor substrate 0S comprises LUT 170, including a plurality of LUT arrays 170a-170f . . . (FIG. 3C). These LUT arrays 170a-170f are communicatively coupled with the TSVs 160a-160d. The ALC 180 reads data from the BS-LUT 170 through the TSVs 160, and performs arithmetic operations on these data. In the present invention, an LUT array is a collection of all LUT memory cells which share at least an address line.

The BS-LUT 170 may use a RAM or a ROM. The RAM includes SRAM and DRAM. The ROM includes mask ROM, OTP, EPROM, EEPROM and flash memory. The flash memory can be categorized into NOR and NAND, and the NAND can be further categorized into horizontal NAND and vertical NAND. On the other hand, the ALC 180 may comprise an adder, a multiplier, and/or a multiply-accumulator (MAC). It may perform integer operation, fixed-point operation, or floating-point operation.

The BS-LUT processor 300 uses memory-based computation (MBC), which carries out computation primarily with the BS-LUT 170. Compared with the LUT 200X used by the conventional processor 00X, the BS-LUT 170 used by the BS-LUT processor 300 has a much larger capacity. Although arithmetic operations are still performed, the MBC only needs to calculate a polynomial to a lower order because it uses a larger BS-LUT 170 as a starting point for computation. For the MBC, the fraction of computation done by the BS-LUT 170 could be more than the ALC 180.

Because the ALC 100 and the LUT 200 are formed on different sides 0F, 0B of the processor substrate 0S, this type of vertical integration is referred to as double-side integration. The double-side integration has a profound effect on the computational density and computational complexity. For the conventional 2-D integration, the footprint of a conventional processor 00X is roughly equal to the sum of those of the ALU 100X and the LUT 200X. On the other hand, because the double-side integration moves the LUT from aside to the backside 0B, the BS-LUT processor 300 becomes smaller and computationally more powerful. In addition, the total LUT capacity of the conventional processor 00X is less than 100 kb, whereas the total BS-LUT capacity for the BS-LUT processor 300 could reach 100 Gb. Consequently, a single BS-LUT processor 300 could support as many as 10,000 built-in functions (including various types of complex mathematical functions), far more than the conventional processor 00X. Moreover, the double-side integration can improve the communication throughput between the BS-LUT 170 and the ALC 180. Because they are physically close and coupled by a large number of TSV 160, the BS-LUT 170 and the ALC 180 have a larger communication throughput than the LUT 200X and the ALU 100X in the conventional processor 00X. Lastly, the double-side integration benefits manufacturing process. Because the ALC 180 and the LUT 170 are on different sides 0F, 0B of the processor substrate 0S, the logic transistors in the ALC 180 and the memory transistors in the LUT 170 are formed in separate processing steps, which can be individually optimized.

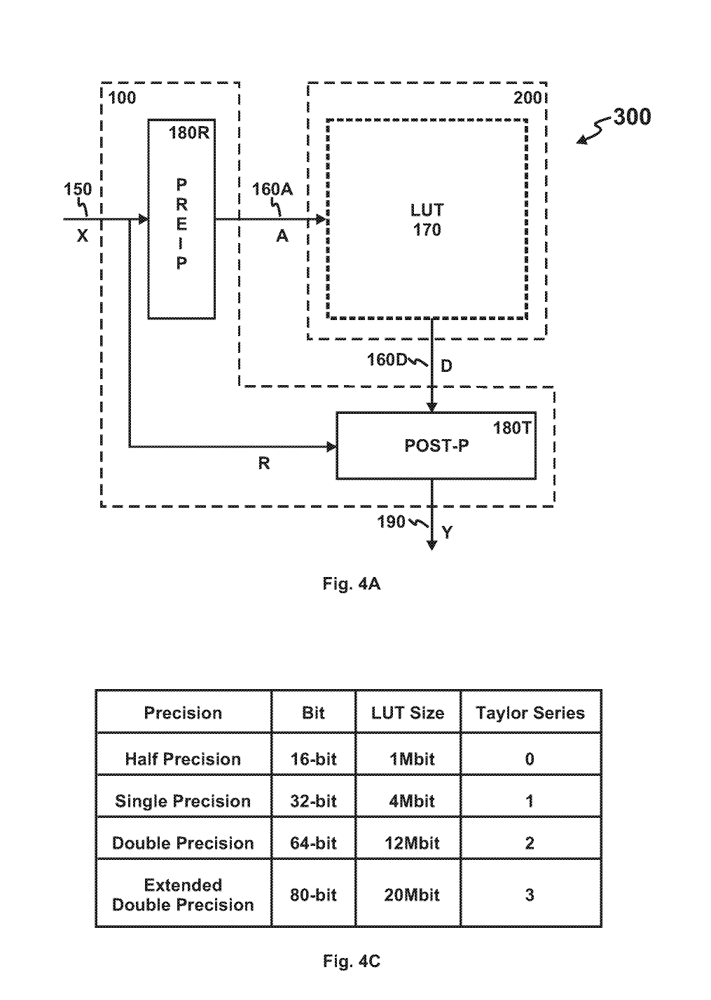

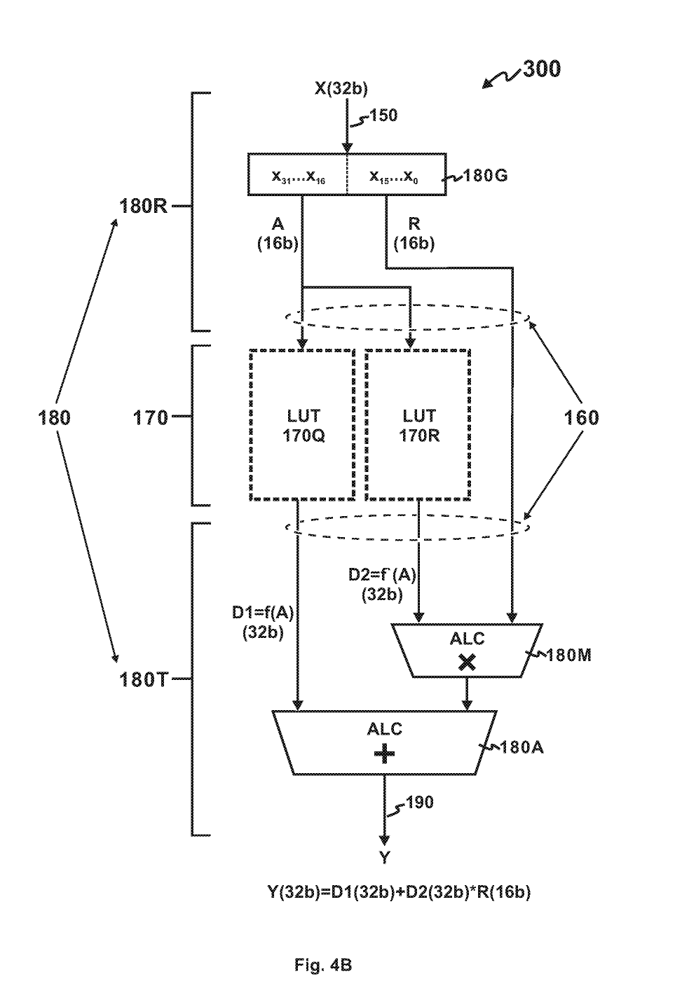

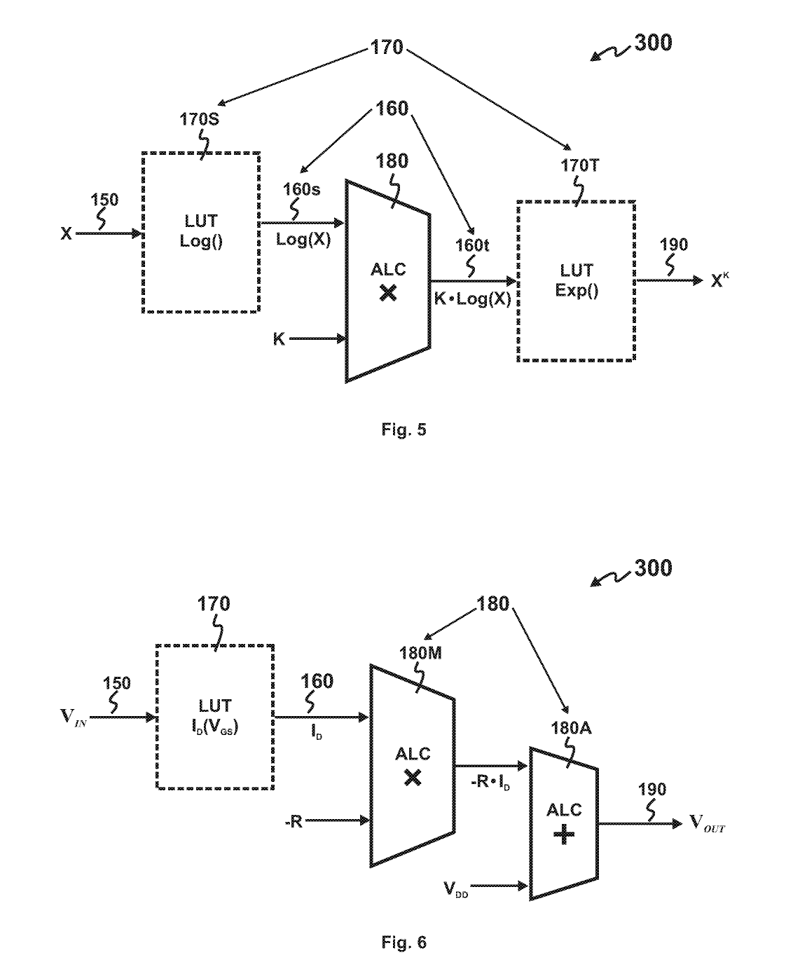

Significantly more built-in functions shall flatten the prevailing framework of scientific computation (including the foundation, function and modeling layers). The hardware-implemented functions, which were only available to the foundation layer in prior art, now become available to the function and modeling layers. Not only the mathematical functions in the function layer can be directly realized by hardware, but also the mathematical models in the modeling layer. In the function layer, the mathematical functions can be realized by a function-by-LUT method (FIGS. 4A-5), i.e. the function values are calculated by interpolating the function-related data stored in the BS-LUT. In the modeling layer, the mathematical models can be realized by a model-by-LUT method (FIG. 6), i.e. the input-output characteristics of a system component are modeled by interpolating the model-related data stored in the BS-LUT. Rapid and efficient computation would lead to a paradigm shift for scientific computation.

Referring now to FIGS. 4A-4C, a preferred BS-LUT processor 300 realizing a mathematical function Y=f(X) is disclosed. FIG. 4A is its simplified block diagram. Its logic circuit 200 comprises a pre-processing circuit 180R and a post-processing circuit 180T, whereas its memory circuit 100 comprises at least a BS-LUT 170 storing the function-related data. The pre-processing circuit 180R converts the input variable (X) 150 into an address (A) 160A of the BS-LUT 170. After the data (D) 160D at the address (A) is read out from the BS-LUT 170, the post-processing circuit 180T converts it into the function value (Y) 190. A residue (R) of the input variable (X) is fed into the post-processing circuit 180T to improve the calculation precision. In this preferred embodiment, the pre-processing circuit 180R and the post-processing circuit 180T are formed in the logic circuit 100. Alternatively, a portion of the pre-processing circuit 180R and the post-processing circuit 180T could be formed in the memory circuit 200.

FIG. 4B shows a preferred BS-LUT processor 300 realizing a single-precision mathematical function Y=f(X) using a function-by-LUT method. The BS-LUT 170 comprises two LUTs 170Q, 170R with 2 Mb capacity each (16-bit input and 32-bit output): the LUT 170Q stores the function value D1=f(A), while the LUT 170R stores the first-order derivative value D2=f′(A). The ALC 180 comprises a pre-processing circuit 180R (mainly comprising an address buffer) and a post-processing circuit 180T (comprising an adder 180A and a multiplier 180M). The through-silicon vias (TSV) 160 transfer data between the ALC 180 and the BS-LUT 170. During computation, a 32-bit input variable X (x₃₁ . . . x₀) is sent to the BS-LUT processor 300 as an input 150. The pre-processing circuit 180R extracts the higher 16 bits (x₃₁ . . . x₁₆) and sends it as a 16-bit address input A to the BS-LUT 170. The pre-processing circuit 180R further extracts the lower 16 bits (x₁₅ . . . x₀) and sends it as a 16-bit input residue R to the post-processing circuit 180T. The post-processing circuit 180T performs a polynomial interpolation to generate a 32-bit output value Y 190. In this case, the polynomial interpolation is a first-order Taylor series: Y(X)=D1+D2*R=f(A)+f′(A)*R. Apparently, a higher-order polynomial interpolation (e.g. higher-order Taylor series) can be used to improve the computation precision.

When realizing a built-in function, combining the LUT with polynomial interpolation can achieve a high precision without using an excessively large LUT. For example, if only LUT (without any polynomial interpolation) is used to realize a single-precision function (32-bit input and 32-bit output), it would have a capacity of 2³²*32=128 Gb. By including polynomial interpolation, significantly smaller LUTs can be used. In the above embodiment, a single-precision function can be realized using a total of 4 Mb LUT (2 Mb for the function values, and 2 Mb for the first-derivative values) in conjunction with a first-order Taylor series. This is significantly less than the LUT-only approach (4 Mb vs. 128 Gb).

FIG. 4C lists the LUT size and Taylor series required to realize mathematical functions with different precisions. It uses a range-reduction method taught by Harrison. For the half precision (16 bit), the required BS-LUT capacity is 2¹⁶*16=1 Mb and no Taylor series is needed; for the single precision (32 bit), the required BS-LUT capacity is 2¹⁶*32*2=4 Mb and a first-order Taylor series is needed; for the double precision (64 bit), the required BS-LUT capacity is 2¹⁶*64*3=12 Mb and a second-order Taylor series is needed; for the extended double precision (80 bit), the required BS-LUT capacity is 2¹⁶*80*4=20 Mb and a third-order Taylor series is needed. As a comparison, to realize the same double precision (64 bit), the Itanium processor needs a 22^{nd}-order Taylor series.

Besides elementary functions, the preferred embodiment of FIGS. 4A-4B can be used to implement non-elementary functions such as special functions. Special functions can be defined by means of power series, generating functions, infinite products, repeated differentiation, integral representation, differential difference, integral, and functional equations, trigonometric series, or other series in orthogonal functions. Important examples of special functions are gamma function, beta function, hyper-geometric functions, confluent hyper-geometric functions, Bessel functions, Legrendre functions, parabolic cylinder functions, integral sine, integral cosine, incomplete gamma function, incomplete beta function, probability integrals, various classes of orthogonal polynomials, elliptic functions, elliptic integrals, Lame functions, Mathieu functions, Riemann zeta function, automorphic functions, and others. The BS-LUT processor will simplify the computation of special functions and promote their applications in scientific computation.

Referring now to FIG. 5, a preferred BS-LUT processor realizing a composite function using a function-by-LUT method is shown. The BS-LUT 170 comprises two LUTs 170S, 170T, which stores the function values of Log( ) and Exp( ), respectively. The ALC 180 comprises a multiplier 180M. During computation, the input variable X is used as an address 150 for the LUT 170S. The output Log(X) 160s from the LUT 170S is multiplied by an exponent parameter K at the multiplier 180M. The multiplication result K*Log(X) is used as an address 160t for the LUT 170T, whose output 190 is Y=X^{K}.

To improve the speed and efficiency of modeling and simulation, the present invention discloses a simulation processor with a BS-LUT (i.e. BS-LUT simulation processor). This BS-LUT simulation processor is a BS-LUT processor used for modeling and simulation. The to-be-simulated system (e.g. an electrical amplifier 500) comprises at least a to-be-modeled system component (e.g. a transistor 520). The BS-LUT simulation processor comprises a logic circuit and a memory circuit. The BS-LUT in the memory circuit stores data related to a mathematical model of the system component (e.g. the transistor 520), whereas the ALC in the logic circuit performs arithmetic operations on the model-related data. The logic circuit and the memory circuit are formed on different sides 0F, 0B of the processor substrate 0S.

Referring now to FIG. 6, a preferred BS-LUT simulation processor 300 using a model-by-LUT method is disclosed. The BS-LUT 170 stores data related to a mathematical model of the transistor 520. The ALC 180 comprises an adder 180A and a multiplier 180M. During simulation, the input voltage value (V_{IN}) is sent to the BS-LUT 170 as an address 150. The data 160 read out from the BS-LUT 170 is the drain-current value (I_{D}). After the I_{D} value is multiplied with the minus resistance value (−R) of the resistor 510 by the multiplier 180M, the multiplication result (−R*I_{D}) is added to the V_{DD} value by the adder 180A to generate the output voltage value (V_{OUT}) 190.

The BS-LUT 170 could store different forms of the mathematical models. In a first case, the mathematical model is raw measurement data. One example is the measured drain current vs. the applied gate-source voltage (I_{D}-V_{GS}) characteristics of the transistor 520. In a second case, the measurement data is the smoothed measurement data. The raw measurement data is smoothed using either a purely mathematical method (e.g. a best-fit model) or a physical transistor model (e.g. a BSIM4 transistor model). In a third case, the mathematical model includes not only the measured data, but also its derivative values. For example, the mathematical model includes not only the drain-current values of the transistor 520 (e.g. the I_{D}-V_{GS} characteristics), but also its transconductance values (e.g. the Gₘ-V_{GS} characteristics). With derivative values, polynomial interpolation can be used to improve the modeling precision using a BS-LUT 170 with a reasonable size.

The above model-by-LUT approach skips two software-decomposition steps altogether (from a mathematical model to mathematical functions; and, from mathematical functions to built-in functions). To those skilled in the art, a function-by-LUT approach may sound more familiar and less aggressive. In the function-by-LUT approach, only one software-decomposition step is skipped: a mathematical model is first decomposed into a combination of intermediate functions, then these intermediate functions are realized by function-by-LUT. Surprisingly, the model-by-LUT approach needs less LUT than the function-by-LUT approach. Because a transistor model (e.g. BSIM4) has hundreds of model parameters, computing the intermediate functions of the transistor model requires extremely large LUTs. However, if function-by-LUT is skipped (i.e. skipping the transistor models and the associated intermediate functions), the transistor behaviors can be described using only three parameters (including the gate-source voltage V_{GS}, the drain-source voltage V_{DS}, and the body-source voltage V_{Bs}), which requires relatively small LUTs. Consequently, the model-by-LUT approach saves substantial simulation time and energy.

While illustrative embodiments have been shown and described, it would be apparent to those skilled in the art that many more modifications than that have been mentioned above are possible without departing from the inventive concepts set forth therein. For example, the processor could be a micro-controller, a central processing unit (CPU), a digital signal processor (DSP), a graphic processing unit (GPU), a network-security processor, an encryption/decryption processor, an encoding/decoding processor, a neural-network processor, or an artificial intelligence (Al) processor. These processors can be found in consumer electronic devices (e.g. personal computers, video game machines, smart phones) as well as engineering and scientific workstations and server machines. The invention, therefore, is not to be limited except in the spirit of the appended claims.

What is claimed is:

1. A simulation processor for simulating a system comprising a system component, comprising:
a semiconductor substrate comprising a front side and a backside;
a look-up table circuit (LUT) formed on said backside for storing data related to a mathematical model of said system component;
an arithmetic logic circuit (ALC) formed on said front side for performing arithmetic operations on said data; and
a plurality of through-silicon vias (TSV) through said semiconductor substrate for communicatively coupling said memory circuit and said logic circuit.

2. The simulation processor according to claim 1, wherein said LUT is a RAM.

3. The simulation processor according to claim 2, wherein said RAM is a SRAM.

4. The simulation processor according to claim 2, wherein said RAM is a DRAM.

5. The simulation processor according to claim 1, wherein said LUT is a ROM.

6. The simulation processor according to claim 5, wherein said ROM is a mask ROM.

7. The simulation processor according to claim 5, wherein said ROM is an OTP.

8. The simulation processor according to claim 5, wherein said ROM is an EPROM or an EEPROM.

9. The simulation processor according to claim 5, wherein said ROM is a flash memory.

10. The simulation processor according to claim 1, wherein said LUT stores raw measurement data of said system component.

11. The simulation processor according to claim 1, wherein said LUT stores smoothed measurement data of said system component.

12. The simulation processor according to claim 11, wherein said measurement data is smoothed by a mathematical method.

13. The simulation processor according to claim 11, wherein said measurement data is smoothed by a physical model.

14. The simulation processor according to claim 1, wherein said LUT stores derivative values of measurement data of said system component.

15. The simulation processor according to claim 1, wherein said ALC comprises an adder.

16. The simulation processor according to claim 1, wherein said ALC comprises a multiplier.

17. The simulation processor according to claim 1, wherein said ALC comprises a multiply-accumulator (MAC).

18. The simulation processor according to claim 1, wherein said ALC performs integer operations.

19. The simulation processor according to claim 1, wherein said ALC performs fixed-point operations.

20. The simulation processor according to claim 1, wherein said ALC performs floating-point operations.
